(19) United States
(12) Patent Application Publication
(10) Pub. No.: US 2012/0034390 A1
(43) Pub. Date: Feb. 9, 2012

(54) METHOD OF FORMING HIERARCHICAL MICROSTRUCTURE USING PARTIAL CURING

(76) Inventors: Kahp Yang Suh, Seoul (KR); Hoon Eui Jeong, Seoul (KR); No Kyun Kwak, Seoul (KR)

(21) Appl. No.: 13/265,521

(22) PCT Filed: Apr. 20, 2009
(86) PCT No.: PCT/KR09/02052

§ 371 Date: Oct. 20, 2011

(51) Int. Cl. B82B 3/00

(52) U.S. Cl. 427/510

(57) ABSTRACT

Disclosed is a method of forming a hierarchical microstructure using partial curing, which is simple in the manufacturing process and capable of forming a hierarchical structure without heterogeneous interfaces. To this end, there is provided a method of forming a hierarchical microstructure using partial curing, including forming a first polymer pattern having partial curing layers and forming a second polymer pattern on the first polymer pattern by using the partial curing layers. According to the present invention, a microstructure having various hierarchical structures can be formed by using a simple process. Accordingly, efficiency in various processes in which a microstructure having various hierarchical structures needs to be formed and economic efficiency can be improved. Furthermore, new functional materials, having not only super hydrophobicity, but also a high adhesive property even in a rough surface, can be developed.

### BACKGROUND OF THE INVENTION

1. Field of the Invention

The present invention relates to a method of forming a hierarchical microstructure using partial curing and, more particularly, to a method of forming a hierarchical microstructure using partial curing, which is simple in the manufacturing process and capable of forming a hierarchical structure without heterogeneous interfaces.

2. Background of the Related Art

Most of industrial components are being reduced in size until a recent date since the 1890's. According to this tendency, there is a growing need to form a structure of a micro- or nano-size (hereinafter referred to as a ‘microstructure’). In order to meet this need, there are being proposed a variety of technologies for forming a reliable microstructure economically and easily.

Nanoimprint lithography technology has been known as a representative method of forming the microstructure. This method is advantageous in that a small structure of several tens of nano-in size can be fabricated by using a mold having great strength.

It is, however, not easy to form a pattern by using an engraved mold or a mold having patterns with various sizes because a mold having great strength is used and strong pressure of 1900 psi is used and not easy to form the pattern in a wide area. Furthermore, above all, there is a disadvantage in that it is difficult to form a structure having a high aspect ratio.

In order to overcome the problems, a variety of soft lithography technologies using a relatively soft and elastic mold not a stiff mold have been developed. An example of the technologies may include a micro-contact printing method.

This method is advantageous in that a desired pattern without the remaining layer on a substrate can be formed. This method is, however, advantageous in that a structure having a high aspect ratio cannot be fabricated because chemicals, such as PDMS, are used.

In addition, there has been known a technology called so-called Micromolding In Capillaries (MIMIC) which is a sort of the soft lithography technology. According to this technology, a 3-D structure of a micro-size can be fabricated by placing a PDMS mold having a pattern on a substrate and flowing a fluid from the side of the mold.

If the method is repeatedly applied to several layers, a high 3-D structure can be fabricated. This method, however, has a difficult and complicated process because molds of several layers must be precisely arranged in order to fabricate a reliable microstructure.

In addition, there have been developed a variety of soft lithography technologies. Most of the soft lithography technologies are advantageous in that they may be used to fabricate a 3-D microstructure having a wide area because a PDMS mold having weak strength and elasticity is used, but have a definite limit because a structure of a nano-size is difficult to be formed.

As a competition in a reduction in the size of industrial components is recently being accelerated, there is an increasing demand to develop a variety of multi-scale microstructures having hierarchical structures. An example of the microstructure having the hierarchical structure includes a hierarchical structure including complex micro-scale and nano-scale, a polymer bridge structure dangled in spaced, etc.

There is a need to develop the hierarchical structure including complex micro-scale and nano-scale in the fields of biomimicry, optical elements, electrical and electronic elements, and microfluidic elements because hierarchical structure may be assigned surface and optical characteristics as compared with a monolithic structure. The recent search has found that a double roughness structure in the sole of the foot of a gecko lizard or in the surface of the leaf of a lotus flower which is found in nature has good adhesion ability even in a super hydrophobic surface and a bent object.

All methods, such as self-assembly, electrochemical deposition, and phase separation, which have so far been developed to obtain the dual structure are, however, problematic in that the dual structure cannot be precisely fabricated.

More particularly, if a photolithography method is used in order to form a microstructure having the dual structure, a micro-mask and a nano-mask are necessary to obtain the hierarchical structure of the present invention, which is inefficient in terms of the cost. Furthermore, if a lithography method using an e-beam is used, accuracy is high, but the process speed is slow and large-area patterning is difficult. Moreover, if the existing nano-imprinting lithography method is used, high pressure is necessary and it is difficult to fabricate a structure having a high aspect ratio because a micro-based structure collapses.

Furthermore, there is a need to develop the above-described bridge structure in various places, such as smart electrical and electronic devices, optical devices, and micro-fluidic systems. In order to obtain a monolithic bridge structure, a variety of methods, such as reversible imprinting, micro-transfer molding, edge lithography, direct drawing, and electrochemical patterning, have so far been developed.

The methods, however, are problematic in that it is difficult to control the size of a pattern, uniform large-area patterning is difficult, and long turn-around time is required. In particular, a bridge structure fabricated using the existing method is problematic in that a structural combination is low because heterogeneous interfaces are included between a base structure and the bridge structure, contact resistance is increased in electrical elements, and partial leakage of water is generated in a multi-layer channel.

Meanwhile, if a polymer pattern is fabricated by using common ultraviolet rays (UV)-curable polymer, it has been known that oxygen existing between a polymer thin film where the polymer pattern is formed and a mold has an adverse effect on forming a reliable polymer pattern. More particularly, oxygen reacts with the radicals of a photo initiator in a free-radical polymerization reaction and hinders the polymerization reaction of polymer. Accordingly, a partially cured pattern surface has adhesiveness because a surface of the formed polymer pattern is not sufficiently cured, and the optical characteristic and the surface characteristic of the polymer pattern are deteriorated. For this reason, efforts have been made to form a reliable polymer pattern of a high aspect ratio by removing oxygen existing between the polymer thin film and the mold.

If the partial curing phenomenon due to oxygen which has been recognized as a phenomenon to be overcome in forming a polymer pattern may be used to form a microstructure having a hierarchical structure, additional efforts to remove oxygen need not to be made, and a hierarchical structure without heterogeneous interfaces may be formed using a simple method.

### SUMMARY OF THE INVENTION

Accordingly, the present invention has been made in view of the above problems occurring in the prior art, and it is an object of the present invention to provide a method of forming a microstructure using partial curing, which can easily control a pattern size, has uniform large-area patterning, require a relatively short turn-around time, and provide a high optical characteristic by providing a monolithic dual-scale structure without heterogeneous interfaces using the partial curing phenomenon due to oxygen and a capillary force lithography method.

To achieve the above object, an embodiment of the present invention provides a method of forming a hierarchical microstructure using partial curing, including the steps of forming a first polymer pattern having partial curing layers and forming a second polymer pattern on the first polymer pattern by using the partial curing layers.

To achieve the above object, another embodiment of the present invention provides a method of forming a hierarchical microstructure using partial curing, including the steps of flowing a ultraviolet-curable polymer thin film by capillary force by bringing a first mold in contact with the ultraviolet-curable polymer thin film, forming a first polymer pattern having partial curing layers by radiating the flown polymer thin film with ultraviolet rays, flowing the partial curing layers by capillary force by bringing a second mold in contact with the partial curing layers, and forming a second polymer pattern by radiating the flown partial curing layers with ultraviolet rays.

To achieve the above object, yet another embodiment of the present invention provides a method of forming a hierarchical microstructure using partial curing, including the steps of flowing a ultraviolet-curable polymer thin film by capillary force by bringing a first mold in contact with the ultraviolet-curable polymer thin film, forming a first polymer pattern having partial curing layers by radiating the flown polymer thin film with ultraviolet rays, placing a second mold on the partial curing layers by a specific pressure and transferring the partial curing layers to the second mold, and forming a bridge structure in which the flown partial curing layers moves along the second mold and connects to an adjacent first polymer pattern by applying a decompression condition to the flown partial curing layers.

### BRIEF DESCRIPTION OF THE DRAWINGS

Further objects and advantages of the invention can be more fully understood from the following detailed description taken in conjunction with the accompanying drawings in which:

FIGS. 1 to 6 are cross-sectional views illustrating a method of forming a microstructure according to an embodiment of the present invention;

FIGS. 7 to 12 are cross-sectional views illustrating a method of forming a microstructure according to another embodiment of the present invention;

FIG. 13 is a scanning electron microscope photograph showing a microstructure having a micro-/nano-hierarchical structure according to an embodiment of the present invention;

FIG. 14 is a graph showing elastic moduli and hardness according to the UV exposure time of a polymer thin film according to an embodiment of the present invention;

FIG. 15 is a graph showing elastic moduli and hardness according to the UV exposure time of a polymer thin film according to another embodiment of the present invention;

FIG. 16 is a scanning electron microscope photograph showing a microstructure having a base/bridge hierarchical structure according to an embodiment of the present invention;

FIGS. 17 and 18 are scanning electron microscope photographs showing the comparison examples of a microstructure having a base/bridge hierarchical structure according to an embodiment of the present invention; and

FIGS. 19 and 20 are scanning electron microscope photographs showing the microstructure having the base/bridge hierarchical structure according to the embodiment of the present invention and a monolithic microstructure.

### DESCRIPTION OF REFERENCE NUMERALS OF PRINCIPAL ELEMENTS IN THE DRAWINGS

| | |
|---|---|
| 10: substrate | 20: polymer thin film |
| 22: full curing layer | 24: partial curing layer |
| 26: first polymer pattern | 28: second polymer pattern |
| 50′ and 50″: first mold | 60′ and 60″: second mold |

### DETAILED DESCRIPTION OF EMBODIMENTS

Some exemplary embodiments of the present invention will now be described in detail with reference to the accompanying drawings.

In a method of forming a microstructure according to an embodiment of the present invention, first, a first polymer pattern having partial curing layers is formed. A second polymer pattern is formed on the first polymer pattern by using the partial curing layers. Here, it is preferred that the first polymer pattern be formed of ultraviolet-curable polymer, such as polyurethane acrylate (PUA), polyethylene glycol diacrylate (PEG-DA), polyester acrylate, or perfluorinatedpolyether dimethacrylate (PFPE-DMA).

A method forming the first polymer pattern is not specially limited. For example, a first mold is placed on an ultraviolet-curable polymer thin film. The polymer thin film flows into the engraved portions of the first mold by means of capillary force, thus filling the engraved portions. Next, the first polymer pattern having the partial curing layers is formed by radiating the flowed polymer thin film with ultraviolet rays.

The time taken to radiate ultraviolet rays in order to form the partial curing layers may be varied according to the properties (whether the mold has a porous structure that transmits air, etc.) of a mold, a type of the polymer thin film, and so on. For example, if PUA is used as the polymer thin film and PUA or PDMS material is used as the mold, the partial curing layers of about 5 μm or less may be formed by radiating ultraviolet rays for about 5 to 21 seconds.

Next, when a second mold is placed on the partial curing layers, the partial curing layers are flown according to a method, such as transfer due to pressure applied to the second mold, vertical movement to the engraved portions of the second mold due to capillary force, or lateral movement under a decompression process, thereby forming the second polymer pattern. The second polymer pattern formed by this process may have a pattern structure formed on the first polymer pattern or may have a bridge structure connected to the first polymer pattern adjacent to the second polymer pattern.

Methods of forming a hierarchical microstructure using partial curing according to exemplary embodiments of the present invention are described below in detail with reference to the accompanying drawings.

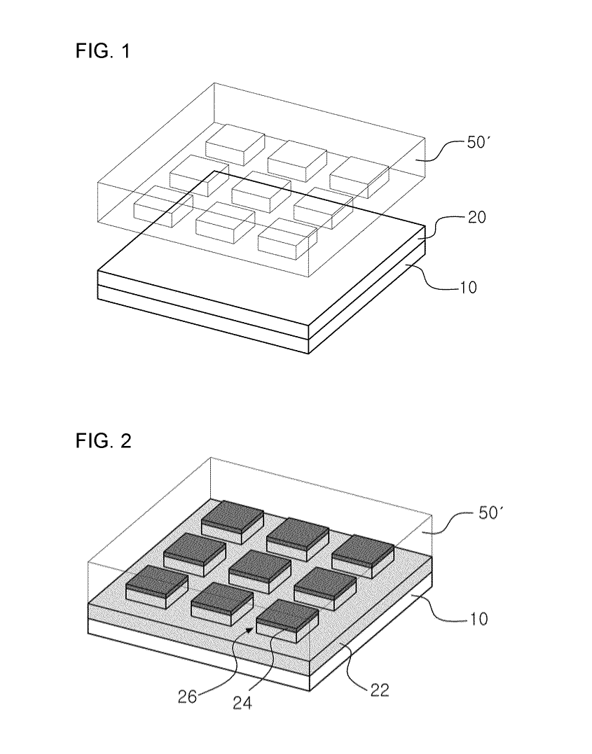

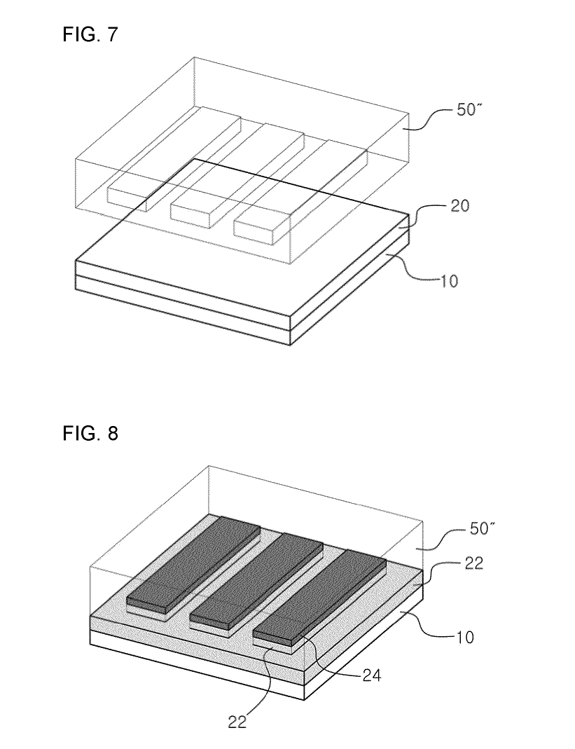

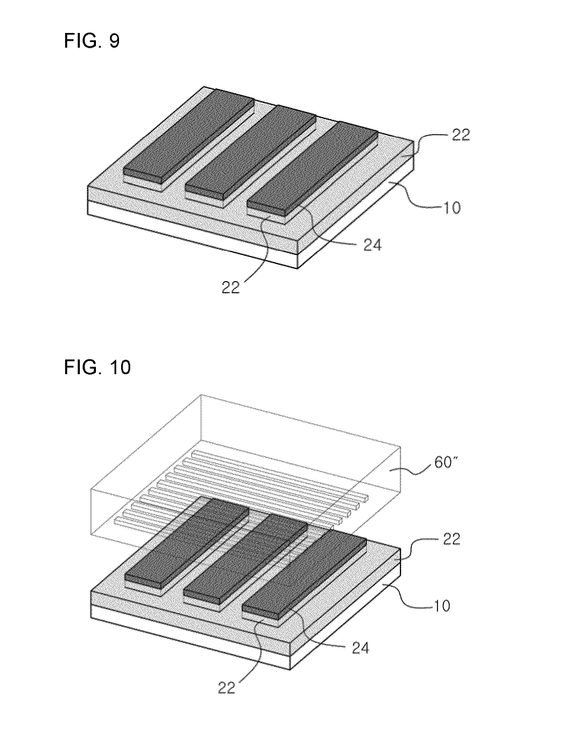

FIGS. 1 to 6 are perspective views illustrating a method of forming a microstructure according to an embodiment of the present invention, and FIGS. 7 to 12 are perspective views illustrating a method of forming a microstructure according to another embodiment of the present invention.

Referring to FIGS. 1 to 12, in the method of forming a microstructure according to the embodiment of the present invention, first, a first polymer pattern 26 having partial curing layers 24 is formed. A second polymer pattern 28 is formed on the first polymer pattern by using the partial curing layers 24.

For example, the first polymer pattern 26 having the partial curing layers 24 may be formed by bringing a substrate 10, having a polymer thin film 20 formed therein, in contact with a first mold 50′, 50″ equipped with engraved portions and embossed portions so that the polymer thin film 20 is flown. The second polymer pattern 28 may be formed by separating the partial curing layers 24 from the first mold 50′, 50″ and the bringing the partial curing layers 24 in contact with a second mold 60′, 60″ so that the partial curing layers 24 is flown.

The method of forming a microstructure according to the embodiment of the present invention may further include the step of controlling the amount of oxygen existing between the first polymer thin film and the first mold before the step of forming the first polymer pattern 26.

It is preferred that a ultraviolet-curable polymer be used as the polymer thin film 20. Furthermore, patterns consisting of the embossed portions and the engraved portions are formed on surfaces coming into contact with the polymer thin film 20, of the first mold 50′, 50″ and the second mold 60′, 60″.

The partial curing layers 24 are formed by radiating ultraviolet rays for a given time after the polymer thin film 20 brought in contact with the first mold 50′, 50″ is flown along the first mold. More particularly, when the polymer thin film 20 is brought in contact with the first mold 50 having the pattern formed thereon, part of the polymer thin film 20 is introduced into the empty spaces of the engraved portions of the first mold 50 by means of capillary force, thereby forming the pattern. As described above, the partial curing layers 24 are formed because a top surface of the polymer material introduced into the engraved portions is hindered from being cured by oxygen existing in the engraved portions. A full curing layer 22 is formed under the partial curing layers 24 because the full curing layer 22 does not come into contact with oxygen. In other words, the first polymer pattern 26 includes the partial curing layers 24 and the full curing layer 22 provided under the partial curing layers 24.

Each of the embodiments is described in detail below.

Referring to FIGS. 1 and 2, first, the first mold 50′ patterned, for example, in a micro-scale is brought in contact with the substrate 10 including the polymer thin film 20 made of the ultraviolet-curable polymer (step S10).

The substrate 10 may be, for example, a silicon substrate, a metal substrate, a polymer substrate, a glass substrate, or a PET film. For example, the substrate 10 may be an underlying structure in the semiconductor process. It is preferred that ultraviolet-curable resin, such as polyurethane acrylate (PUA), poly(ethylene glycol)diacrylate, or perfluorinatedpolyether dimethacrylate which is flown and cured when being radiated with ultraviolet rays, be used as the polymer thin film 20.

The polymer thin film 20 may be formed on the top of the substrate 10 by using a spin-coating method which is widely used to form a thin film.

Polymer, such as polyurethane acrylate (PUA) or poly-dimethylsiloxane (PDMS), or inorganic substance, such as silicon oxide (SiO₂), may be used as the first mold 50′ solely or in combination. Here, the term ‘mold patterned in a micro-scale’ refers to a mold in which embossed portions and engraved portions are formed in a micro-meter size so that a structure having a size of several tens of micrometers can be formed through the mold.

In some embodiments, after the first mold 50′ is brought in contact with the polymer thin film 20, specific pressure may be applied to the first mold 50′ so that the pattern surfaces of the polymer thin film 20 and the first mold 50′ can be uniformly brought in contact with each other. Here, it is preferred that the pressure be about 0.1 to 10 atmosphere. If the pressure less than about 0.1 atmosphere is applied to the first mold 50′, it is difficult to expect an effect that accelerates a capillary effect through a uniform contact between the pattern surfaces of the polymer thin film 20 and the first mold 50. Furthermore, if the pressure exceeding about 10 atmosphere is applied to the first mold 50′, a micropattern is not formed by a capillary phenomenon intended in the present invention, but a pattern according to pressure is formed as in the existing invention.

In general, polymer commonly has a glass transition temperature Tg. When the temperature is reached, the polymer shows a liquid property and has fluidity. Here, if a mold (a prototype) having a shape that can pull the polymer up is brought in contact with the polymer, the polymer moves along the shape of the mold by means of a capillary phenomenon.

In this step, the empty portions (that is, the engraved portions) of the first mold 50′ are filled with the polymer thin film 20 according to the capillary phenomenon, preferably, so that the polymer thin film 20 is brought in contact with the bottom surface (ceiling) of the engraved portions.

More particularly, if a substance forming the polymer thin film 20 is a polymer substance having fluidity at normal temperature, a polymer pattern can be formed according to a capillary phenomenon which is generated when the first mold 50′ is closely brought in contact with the polymer thin film 20. If a substance forming the polymer thin film 20 is a polymer substance not having fluidity at normal temperature, a capillary phenomenon may be caused by performing an annealing process under a specific temperature condition as described above. If a polymer substance forming the polymer thin film 20 does not have fluidity, a capillary phenomenon may be generated by infiltrating (or absorbing) a solvent, etc. into the polymer thin film 20 in order to secure fluidity.

The polymer thin film 20 fills the engraved portions of the first mold 50′ according to the capillary phenomenon as described above and consequently comes into contact with the bottom surface (ceiling) of the engraved portions of the first mold 50′. When ultraviolet rays is radiated for a given time, the polymer thin film 20 is partially cured in the state where the engraved portions of the first mold 50′ have been filled with the polymer thin film 20, thereby forming the first polymer pattern 26.

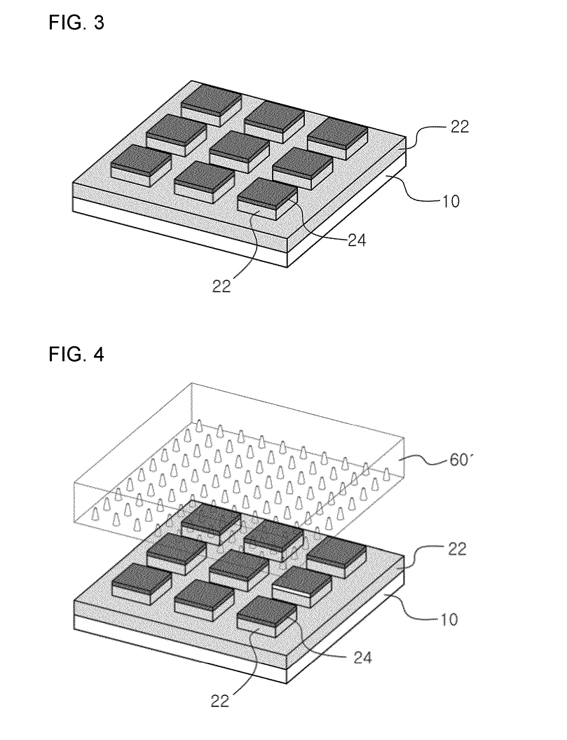

As shown in FIG. 3, the polymer thin film 20 is made to flow into the bottom surface of the engraved portions of the first mold 50′ by radiating the polymer thin film 20 and the first mold 50′ with ultraviolet rays for a given time, thereby forming the first polymer pattern 26 having the partial curing layers 24 (step S20).

In general, in the free-radical polymerization reaction, oxygen hinders the polymerization reaction of polymer through a reaction with the radicals of a photo initiator and thus functions to reduce an adhesive surface, an optical characteristic, and a surface characteristic.

Accordingly, in this step, the partial curing layers 24 are formed on the first polymer pattern 26 by employing a phenomenon in which a polymer substance exposed to ultraviolet rays is partially cured because the polymer substance is hindered from being cured by oxygen. Here, the partial curing layer 24 refers to a curing layer formed to the extent that part of the curing layer can flow into the engraved portions of an additional mold although the curing layer comes into contact with the mold and refers to a curing layer having hardness of, specifically, 10 to 100 MPa, preferably, 10 to 50 MPa and elastic modulus of 100 to 1500 MPa, preferably, 200 to 500 MPa.

More particularly, the top of the polymer substance introduced into the engraved portions of the first mold 50′ is subjected to the phenomenon in which the top of the polymer substance is partially cured by oxygen remaining in the engraved portions when being is exposed to ultraviolet ray, thereby forming the partial curing layers 24, and the full curing layer 22 is formed under the partial curing layers 24. Here, a part (e.g., 1 μm in depth) of the top of the polymer substance adjacent to the bottom surface of the engraved portions is severely exposed to oxygen, so that the part has a low elastic modulus value because the polymerization reaction of the polymer is not much performed. Here, the partial curing layers 24 has a maximum length of about 4 to 5 μm because oxygen does not pass through the polymer substance up to a depth of 5 μm or higher of the top of the polymer substance.

Meanwhile, the ultraviolet rays are radiated to form the partial curing layers 24 on the first polymer pattern 26. If the time taken to radiate the ultraviolet rays is the time enough to form the partial curing layers 24 on the first polymer pattern 26, a range of the time is specially limited. In particular, the time taken to radiate the ultraviolet rays may be changed because the speed that the polymer pattern is cured may be changed according to material used as the first mold 50′. This is because air transmissivity is different according to the material of a mold. It is, however, preferred that UV exposure time be about 5 seconds if a PUA mold is used as the first mold 50′. It is preferred that the UV exposure time be about 21 seconds if a PDMS mold is used as the first mold 50′.

Referring to FIG. 4, the partial curing layers 24 are separated from the first mold 50′ and brought in contact with, for example, the nano-patterned second mold 60′ (step S30).

Polymer, such as polyurethane acrylate (PUA) or poly-dimethylsiloxane (PDMS), or inorganic substance, such as silicon oxide (SiO₂), may be used as the second mold 60′ solely or in combination. Here, the term ‘nano-patterned mold’ refers to a mold in which embossed portions and engraved portions of nanometers in size are formed so that a structure having a size of several tens of nanometers can be formed through the mold.

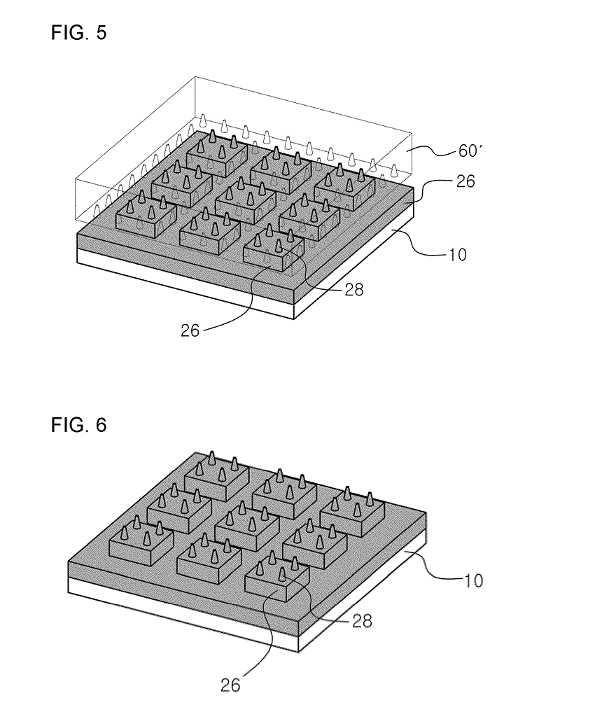

Referring to FIGS. 5 and 6, when the partial curing layers 24 flow into the bottom surface of the engraved portions of the second mold 60′ to thereby form the second polymer pattern 28, the second polymer pattern 28 is cured by radiating the second mold 60′ with ultraviolet rays (step S40).

When the second mold 60′ including the embossed portions and the engraved portions is brought in contact with the partial curing layers 24 having fluidity, part of the partial curing layers 24 moves along the shape of the second mold 60′ according to a capillary phenomenon.

In this step, the empty portions (that is, the engraved portions) of the second mold 60 are filled with the partial curing layers 24 and the partial curing layers 24 is brought in contact with the bottom surface of the engraved portions, by employing the two-step capillary phenomenon.

As described above, the partial curing layers 24 fills the engraved portions of the second mold 60′ according to the capillary phenomenon and consequently comes into contact with the bottom surface (ceiling) of the engraved portions of the second mold 60′, thereby forming the second polymer pattern 28. The second polymer pattern 28 may generally have a ciliary shape because it is a microstructure.

In this step, the second polymer pattern 28 (that is, a microstructure) formed on the first polymer pattern 26 which is a structure of a micro size (hereinafter referred to as a ‘microstructure’) is cured by radiating the second polymer pattern 28 with ultraviolet rays.

The radiation of the ultraviolet rays is used to fully cure the second polymer pattern 28, and thus a range of the time taken to radiate the ultraviolet rays is not specially limited. In particular, the time taken to radiate the ultraviolet rays may be changed because the speed that the polymer pattern is cured may be changed according to material used as the second mold 60.

According to the present embodiment, a microstructure having complex micro/nano-structures can be easily formed. Functional material having an anti-pollution function can be fabricated because material having the microstructure on its surface has strong hydrophobicity. Furthermore, in the method of forming a microstructure according to the present embodiment, chemical and physical stability is improved because a microstructure having a hierarchical structure (monolithic and dual-scale structures) without an interface can be formed.

Although a variety of methods, such as self-assembly, electrochemical deposition, and phase separation, have been developed in order to obtain the dual structure, all the methods are difficult to precisely fabricate a dual structure. Furthermore, if a double roughness structure simulated from a ciliary shape is formed on a surface, a wide surface area is obtained and thus the structure may be applied to the development of material having excellent surface adhesive strength.

The integration type hierarchical structure may be provided in an adhesive, in particular, an artificial dry adhesive. An adhesive provided in the microstructure formed by the present embodiment can increase structural unity and strength for an external load because the adhesive does not include an interface.

That is, the microstructure of the present embodiment may be usefully used to form micropatterns in a semiconductor manufacturing process, etc. and may be widely applied to a ciliary simulation of the natural world.

FIGS. 7 to 12 are cross-sectional views illustrating a method of forming a microstructure according to another embodiment of the present invention.

More particularly, in order to form a base/bridge hierarchical structure using partial curing, a microstructure having the base/bridge hierarchical structure without heterogeneous interfaces is formed on a substrate 10 according to a method including the steps S10 and S20 and S30′ and S40′. A description of the same contents is omitted.

Referring to FIG. 10, partial curing layers 24 are separated from a first mold 50″, and a nano-patterned second mold 60″ is then brought in contact with the partial curing layers 24 by some pressure so that a shape of the second mold 60″ is transferred to the partial curing layers 24. Furthermore, the second mold 60″ may have any pattern, if a bridge structure can be formed on the first polymer pattern 26 (that is, a top of the base structure), but may preferably have a pattern having one or more of a line form, circle, and a mesh form. Here, it is preferred that the second mold 60″ be brought in contact with the partial curing layers 24 at a pressure of about 0.1 to 0.5 bar for the purpose of smooth transfer. If the pressure is lower than about 0.1 bar, the pattern is not sufficiently transferred to the partial curing layers 24. If the pressure exceeds about 0.5 bar, the partial curing layers may collapse.

The partial curing layers 24 still has fluidity even after the pattern is transferred to the partial curing layers 24 by the pressure. Accordingly, part of the partial curing layers 24 may move along the shape of the second mold 60″ according to a capillary phenomenon, resulting in a slightly risen pattern. The movement of the partial curing layers 24 according to the capillary force is not smoothly generated because the partial curing layers 24 have already been partially cured, as compared with the transfer of the first polymer pattern according to the capillary force when the first polymer pattern is formed. Consequently, the movement of the partial curing layers 24 may be insignificant, as compared with the transfer of the pattern according to the shape of the second mold using the pressure, or may not be generated.

The transfer of the partial curing layers according to the pressure or the movement of the partial curing layers according to the capillary force is chiefly generated upwardly from the partial curing layers not a lateral direction.

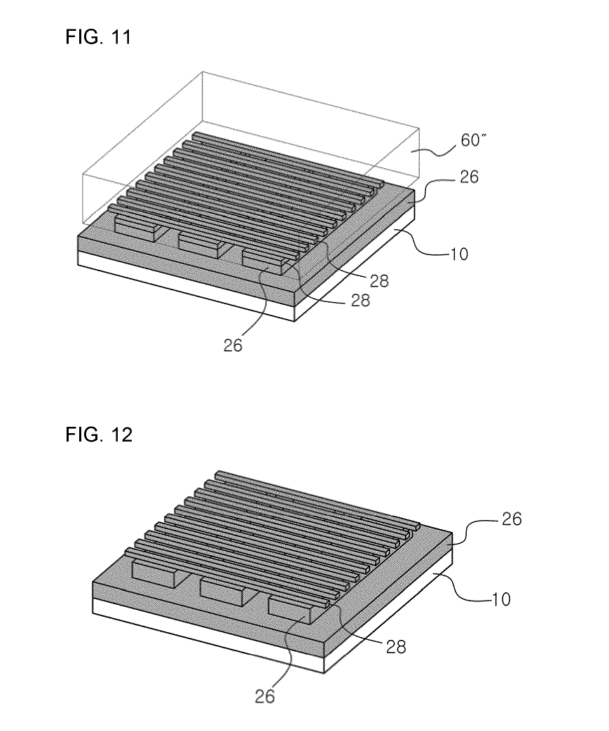

Referring to FIGS. 11 and 12, the partial curing layers 24 are flown along the engraved portions of the second mold 60″ by applying a decompression process to the partial curing layers 24 and the second mold 60″, thereby forming a bridge structure (bridge layer) connected to a first polymer pattern (step S40′).

More particularly, if the decompression process is not used when the second mold 60″ having the embossed portions and the engraved portions patterned thereon is imprinted on the polymer pattern, the partial curing layers 24 move only along the engraved portions of the second mold 60″ formed in a direction vertical to portions directly coming into contact with the second mold 60″, but do not move into the engraved portions included in portions not directly coming into contact with the second mold 60″ according to a capillary phenomenon. In other words, the partial curing layers 24 may come into contact with the bottom surface (ceiling) of the pattern according to a geometric shape of the mold pattern and the degree of partial curing, but if the decompression process is not used, the fluctuation and movement of the partial curing layers 24 in a lateral direction is limited by its high viscosity.

Here, the decompression process is performed within a range of 10⁻² to 10⁻¹² Pa. If the decompression process is stopped before the target pressure (10⁻² Pa) is reached, a broken bridge structure may be formed.

If the decompression process is applied to the second mold 60″ brought in contact with the partial curing layers 24 as described above, the partial curing layers 24 are flown into the entire engraved portions of the second mold 60″ (that is, laterally), with the result that the bridge structure is formed.

According to the present embodiment, a base/bridge hierarchical structure to which the polymer pattern of a micro-size is connected can be formed by only placing a mold, including engraved portions of a nano size, on a polymer pattern (base structure) without special surface processing. That is, according to the present embodiment, a variety of the base/bridge hierarchical structures can be fabricated without collapse of a structure or the sticking of structures.

The microstructure having the base/bridge hierarchical structure according to the present embodiment may be used to fabricate 3-D devices having a multi-scale hierarchical structure, such as electron/fluid-based devices, resonators, and photonic crystals.

As described above, in the method of forming a microstructure according to the present invention, a microstructure having a hierarchical structure without an interface can be formed by using a partial curing phenomenon using oxygen and a capillary force lithography method. Accordingly, efficiency in various processes in which a microstructure having a hierarchical structure needs to be formed and economic efficiency can be improved.

The microstructure of the hierarchical structure without an interface may be applied to a variety of fields. For example, if the method of forming a microstructure according to the present invention is used, various pieces of optimized ciliary of the natural world can be simulated. More particularly, abrasion resistance or drag on the surfaces of various materials can be reduced by simulating a ciliary of a nano level. If this technology is used as means for moving a substrate, etc. instead of the existing electrostatic chuck in a semiconductor process or a display device fabrication process, the object can be smoothly moved while significantly reducing a possibility of pollution.

Furthermore, new functional materials having properties, such as super hydrophobicity or a high adhesive property, can be developed by using the method of forming a microstructure according to the present invention. More particularly, materials having a self-purification function or a moisture-proof function (for example, exterior materials for construction, multi-functional glass for home and industry, and optical lens) can be fabricated by using the material having super hydrophobicity and applied to various industry fields. Furthermore, a robot which can vertically move on the surface of a wall may be developed by using the materials having a high adhesive property. That is, the materials having a high adhesive property may be applied to the development of various industrial technologies, such as national defense, the universe, and industrial robots.

The method of forming a microstructure according to the present invention may be applied to a process of forming a micropattern of a nano size, such as in electronic devices which become more micro and may greatly contribute to the development of various ultra-precision industry technologies along with the recently emerging carbon nanotube.

Furthermore, if the method of forming a microstructure according to the embodiments of the present invention is used, an interface can be obviated from a microstructure having a hierarchical structure (dual structure).

The present invention is described in more detail in connection with embodiments and a comparison example. It is to be noted that the embodiments are described to illustrate the present invention, but the present invention is not limited to the embodiments.

### Embodiment 1

### Formation of the Polymer Thin Film on the Substrate (Step S10)

First, the polymer thin film was formed by coating polyurethane acrylate on a silicon substrate. Here, the coating was performed by using a spin-coating method of 3000 rpm. Contact of the mold and formation of the first polymer pattern (steps S20, S30)

Next, the PUA mold in which the engraved patterns of a desired micro size were engraved was brought in contact with the polymer thin film. Here, the PUA mold was brought in contact with the polymer thin film under atmosphere pressure so that a contact surface was not unfastened (that is, the PUA mold was uniformly brought in contact with the polymer thin film and thus a capillary tube effect was smoothly generated). During this time, the polymer thin film slowly filled the empty portions of the PUA mold and was thus brought in contact with the bottom surface of the engraved parts of the PUA mold.

Next, ultraviolet rays were radiated for 5 seconds.

Next, the PUA mold was removed in a vertical direction, thereby forming the first polymer pattern having the partial curing layers formed therein.

### Formation of the Microstructure (Step S40)

Next, the PUA mold having the engraved ciliary patterns of a nano size engraved therein was brought in contact with the partial curing layers. Here, the PUA mold was brought in contact with the partial curing layers so that a contact surface was not unfastened (that is, the PUA mold was uniformly brought in contact with the partial curing layers and thus a capillary tube effect was smoothly generated). During this time, the partial curing layers slowly filled the empty portions of the PUA mold, and consequently it was brought in contact with the bottom surface of the engraved parts of the PUA mold, thereby forming cilia.

Next, the microstructure having a micro-/nano-hierarchical structure was formed by radiating ultraviolet rays and removing the PUA mold in a vertical direction.

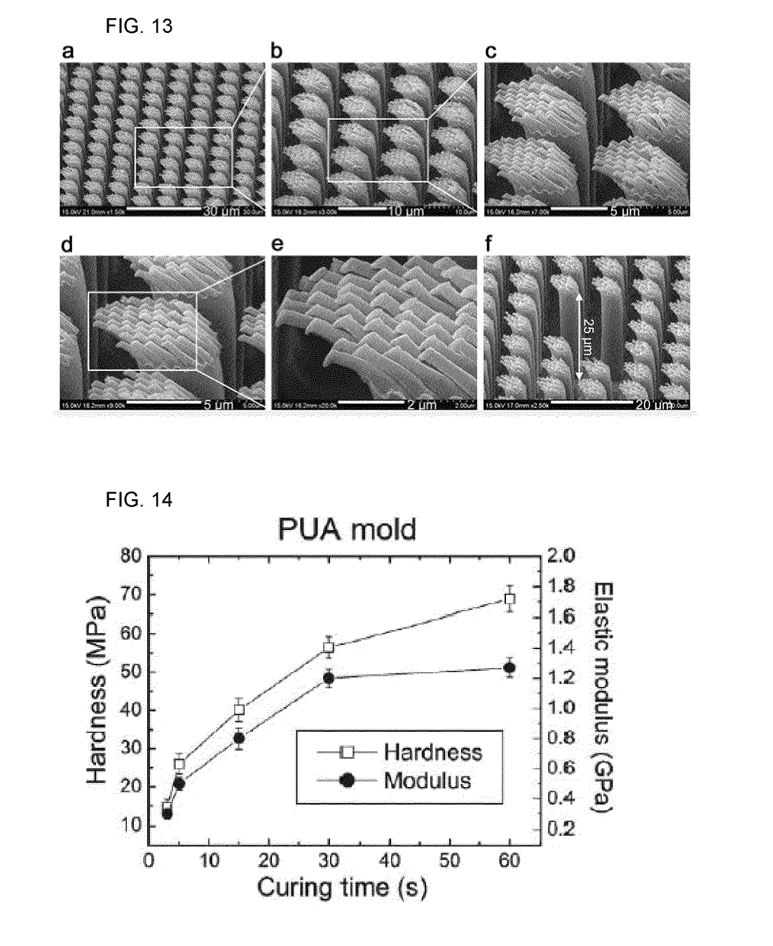

FIG. 13 is a scanning electron microscope (SEM) photograph obtained by monitoring the microstructure, having the micro-/nano-hierarchical structure formed according to the embodiment 1, using a scanning electron microscope (Model Name XL30FEG, Philips' Electronics NV, the Netherlands).

FIG. 14 is a graph showing elastic moduli and hardness according to the UV exposure time of the polymer thin film formed according to the embodiment 1.

From FIG. 14, it could be seen that, if the PUA mold was used as the first mold, optimal partial curing was generated when ultraviolet rays were radiated for about 5 seconds.

### Embodiment 2

### Formation of the Polymer Thin Film on the Substrate (Step S10)

First, the polymer thin film was formed by coating polyurethane acrylate on a silicon substrate. Here, the coating was performed by using a spin-coating method of 3000 rpm. Contact of the mold and formation of the first polymer pattern (steps S20, S30)

Next, the PUA mold in which the engraved patterns of a desired micro size were engraved was brought in contact with the polymer thin film. Here, the PUA mold was brought in contact with the polymer thin film under atmosphere pressure so that a contact surface was not unfastened (that is, the PUA mold was uniformly brought in contact with the polymer thin film and thus a capillary tube effect was smoothly generated). The polymer thin film slowly filled the empty portions of the PUA mold, and consequently it was brought in contact with the bottom surface of the engraved parts of the PUA mold.

Next, ultraviolet rays were radiated for 21 seconds.

Next, the PUA mold was removed in a vertical direction, thereby forming the first polymer pattern having the partial curing layers formed therein.

### Formation of the Microstructure (Step S40)

Next, the PUA mold having the engraved ciliary patterns of a nano size engraved therein was brought in contact with the partial curing layers. Here, the PUA mold was brought in contact with the partial curing layers under 1 atmospheric pressure so that a contact surface was not unfastened (that is, the PUA mold was uniformly brought in contact with the partial curing layers and thus a capillary tube effect was smoothly generated). During this time, the partial curing layers slowly filled the empty portions of the PUA mold, and consequently it was thus brought in contact with the bottom surface of the engraved parts of the PUA mold, thereby forming cilia.

Next, the microstructure having a micro-/nano-hierarchical structure was formed by radiating ultraviolet rays and removing the PUA mold in a vertical direction.

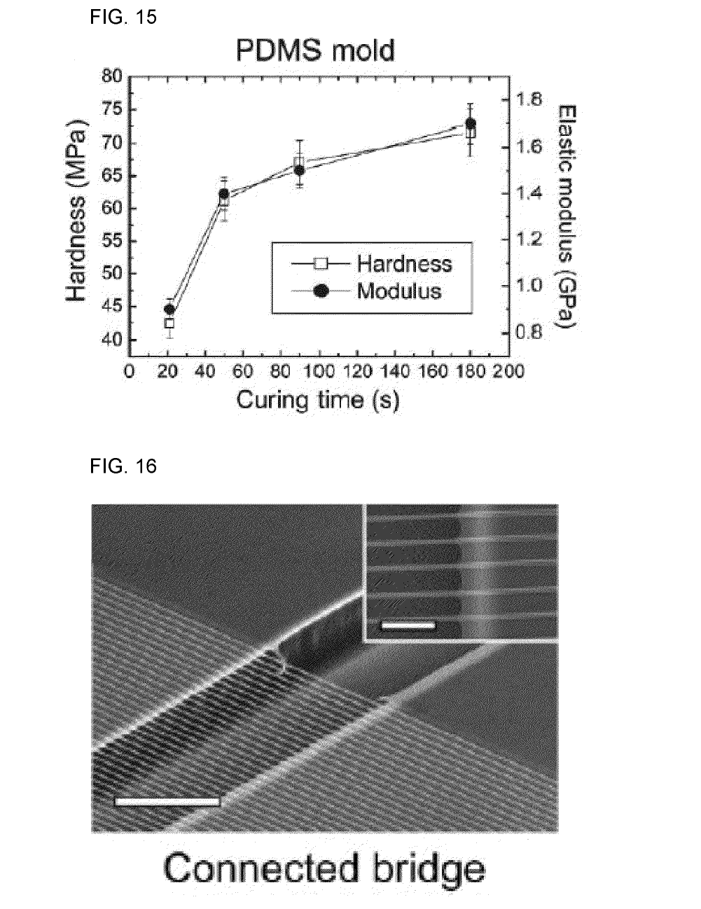

FIG. 15 is a graph showing elastic moduli and hardness according to the UV exposure time of the polymer thin film formed according to the embodiment 2.

From FIG. 15, it could be seen that, if the PUA mold was used as the first mold, optimal partial curing was generated when ultraviolet rays were radiated for about 21 seconds.

### Embodiment 3

### Formation of the Polymer Thin Film on the Substrate (Step S10)

First, the polymer thin film was formed by coating polyurethane acrylate on a silicon substrate. Here, the coating was performed by using a spin-coating method of 3000 rpm. Contact of the mold and formation of the first polymer pattern (steps S20, S30′)

Next, the PUA mold in which the engraved patterns of a desired micro size were engraved was brought in contact with the polymer thin film. Here, the PUA mold was brought in contact with the polymer thin film under 1 atmosphere pressure so that a contact surface was not unfastened (that is, the PUA mold was uniformly brought in contact with the polymer thin film and thus a capillary tube effect was smoothly generated). The polymer thin film slowly filled the empty portions of the PUA mold, and consequently it was brought in contact with the bottom surface of the engraved parts of the PUA mold.

Next, ultraviolet rays were radiated for 10 seconds.

Next, the PUA mold was removed in a vertical direction, thereby forming the first polymer pattern having the partial curing layers formed therein.

### Formation of the Microstructure (Step S40′)

Next, the PUA mold having the engraved ciliary patterns of a nano size was brought in contact with the partial curing layers by applying pressure of 0.1 bar to the PUA mold in a direction opposite to the micro-meter engraved patterns so that a pattern of the PUA mold was transferred to the partial curing layers. Next, the air pressure of a vacuum chamber dropped to 10⁻² Pa. Here, the partial curing layers fully filled the empty portions of the PUA mold laterally formed, thereby forming the bridge structure (bridge layer) for the polymer pattern.

Next, the base/bridge hierarchical structure having the microstructure was formed by curing the bridge structure with ultraviolet rays and removing the PUA mold in a vertical direction.

FIG. 16 is a scanning electron microscope (SEM) photograph obtained by monitoring the microstructure, having the based/bridge hierarchical structure formed according to the embodiment 3, using a scanning electron microscope (Model Name XL30FEG, Philips' Electronics NV, the Netherlands).

From FIG. 16, it could be seen that, if the PUA mold having a nano-channel channel was imprinted on the micro-base structure and a decompression process was used, partial cured polymer flowed into the nano-channel to form the bridge structure.

### Comparison Example 1

A conventional microstructure was formed by performing the steps S10 to S20 using the same method as that of the embodiment 1, but by fully curing the first polymer pattern so that the partial curing layers were not formed and then separating the PUA mold from the first polymer pattern.

### Comparison Example 2

A conventional microstructure having a base/bridge hierarchical structure was formed by performing the steps S10 to S40′ using the same method as that of the embodiment 3 without performing a vacuum process at step S40′.

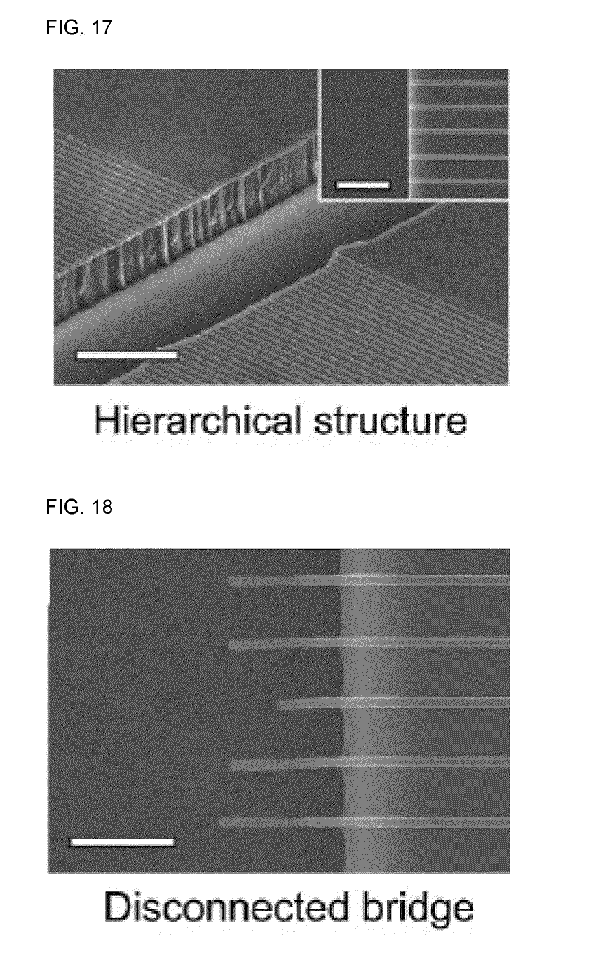

FIG. 17 is a scanning electron microscope (SEM) photograph obtained by monitoring the conventional microstructure, formed according to the comparison example 2, using a scanning electron microscope (Model Name XL30FEG, Philips' Electronics NV, the Netherlands).

From FIG. 17, it could be seen that, if the decompression process of the present embodiment was not used, the partial curing layers were flown to the some extent, but not flown up to the engraved portions of the PUA mold formed in a horizontal direction.

That is, it could be seen that the partially cured polymer resin might be flown in a direction vertical to the engraved portions, included in the mold, according to the degree of the cured resin, but the movement of the cured polymer resin was limited in a direction horizontal to the engraved portions.

### Comparison Example 3

A conventional microstructure having a base/bridge hierarchical structure was formed by performing the step S10 to S40′ using the same method as that of the embodiment 3, but by stopping the decompression process before the air pressure of the vacuum chamber reached 10⁻² Pa at step S40′.

FIG. 18 is a scanning electron microscope (SEM) photograph obtained by monitoring the conventional microstructure, formed according to the comparison example 3, using a scanning electron microscope (Model Name XL30FEG, Philips' Electronics NV, the Netherlands).

From FIG. 18, it could be seen that a broken bridge structure could be formed if the decompression process was stopped before the air pressure of the vacuum chamber reached 10⁻² Pa.

### Experiment Example

### Hydrophobicity Experiment on the Conventional Microstructure and the Microstructure Having the Hierarchical Structure

A hydrophobicity experiment on the microstructure formed according to the embodiment 1 and the conventional microstructure formed according to the comparison example 1 was performed.

In order to perform the hydrophobicity experiment, the surfaces of the microstructure and the conventional microstructure were processed by trichloro (1H,1H,2H,2H-perfluorooctyl)-silane.

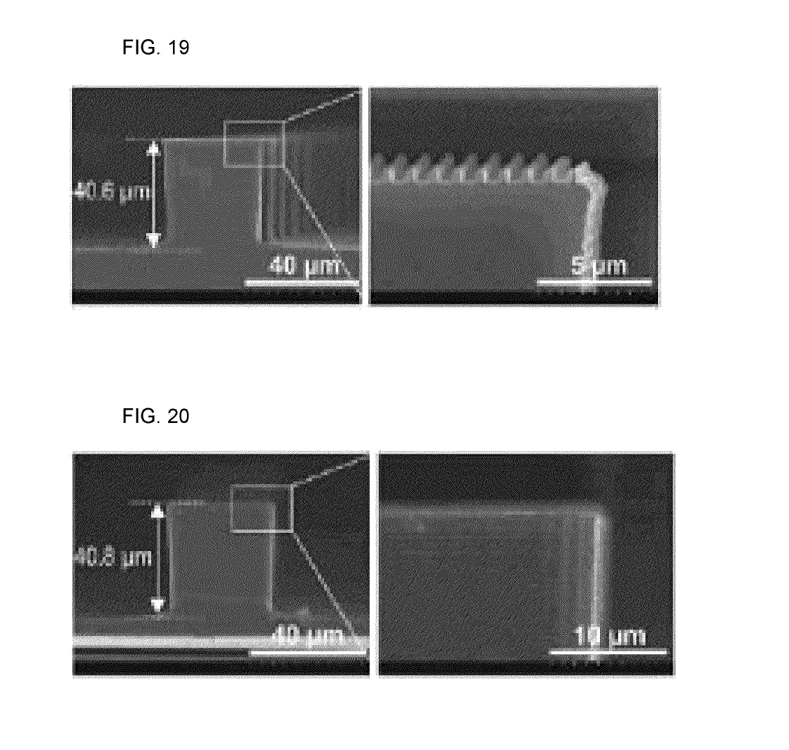

FIGS. 19 and 20 are scanning electron microscope (SEM) photographs obtained by monitoring the microstructure having the dual hierarchical structure and the conventional microstructure having a monolithic microstructure using a scanning electron microscope (Model Name XL30FEG, Philips' Electronics NV, the Netherlands), which show contact characteristics tested for the structures.

As a result of a contact angle measured for the hydrophobicity experiment, it was found that the conventional microstructure had a contact angle of about 156°, but then had a contact angle of about 121° which had a more stable Wenzel state after losing a normal Cassie state when mechanical vibration was applied to the microstructure.

On the other hand, it was found that the microstructure of the present invention had a hydrophobicity surface (about) 166° having an increased contact angle and maintained the normal Cassie state more stably against external force.

Furthermore, it was found that the conventional microstructure had a CAH value of about 30, but the microstructure of the present invention had a CAH value of about 2. Here, the CAH value corresponds to super hydrophobicity according to a lower CAH value. Accordingly, it could be checked that the microstructure of the present invention had super hydrophobicity.

As described above, according to the present invention, microstructure having a variety of hierarchical structures (for example, a micro/nano dual structure and a base/bridge dual structure) can be formed using a simple process. Accordingly, efficiency in various processes in which a microstructure having various hierarchical structures needs to be formed and economic efficiency can be improved. The microstructures having multi-scale may be applied to a variety of fields.

For example, if the method of forming the micro/nano dual structure according to the present invention is used, various optimized cilia of the natural world may be simulated. More particularly, abrasion resistance or drag on the surfaces of various materials can be reduced by simulating a ciliary of a nano level. If this technology is applied to transportation, such as vehicle (in particular, to a surface of large transport means, such as airplanes, ships, and deep sea probes), an excellent fuel saving effect can be expected.

Furthermore, new functional materials having properties, such as super hydrophobicity or a high adhesive property, may be developed by using the method of forming a microstructure according to the present invention. More particularly, materials having a self-purification function or a moisture-proof function (for example, exterior materials for construction, multi-functional glass for home and industry, and optical lens) can be fabricated by using materials having super hydrophobicity and applied to various industry fields.

Furthermore, a robot which can vertically move on the surface of a wall may be developed by using the materials having a high adhesive property formed by the hierarchical structure in a rough surface having roughness of 20 micro or less or in a bend surface. That is, the materials having a high adhesive property may be applied to the development of various industrial technologies, such as national defense, the universe, and industrial robots.

Furthermore, the method of forming a microstructure according to the present invention may be applied to a process of forming a micropattern of a nano size, such as in electronic devices which become more micro and may greatly contribute to the development of various ultra-precision industry technologies along with the recently emerging carbon nanotube.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of forming a hierarchical microstructure using partial curing, the method comprising the steps of:
forming a first polymer pattern having partial curing layers; and
forming a second polymer pattern on the first polymer pattern by using the partial curing layers.

2. The method as claimed in claim 1, wherein the first polymer pattern comprises a ultraviolet-curable polymer.

3. The method as claimed in claim 1, wherein the step of forming the first polymer pattern comprises the steps of:
placing a first mold on a polymer thin film;
flowing the polymer thin film by capillary force; and
forming the first polymer pattern having the partial curing layers by radiating the flown polymer thin film with ultraviolet rays.

4. The method as claimed in claim 3, wherein the ultraviolet rays are radiated for 5 to 21 seconds.

5. The method as claimed in claim 3, wherein the first mold comprises poly-dimethylsiloxane (PDMS) or polyurethane acrylate (PUA).

6. The method as claimed in claim 1, wherein the second polymer pattern is a pattern structure formed on the first polymer pattern or a bridge structure connected to the first polymer pattern adjacent to the second polymer pattern.

7. The method as claimed in claim 1, wherein the step of forming the second polymer pattern comprises the steps of:
placing a second mold on the partial curing layers; and
flowing the partial curing layers to form the second polymer pattern.

8. A method of forming a hierarchical microstructure using partial curing, the method comprising the steps of:
flowing a ultraviolet-curable polymer thin film by capillary force by bringing a first mold in contact with the ultraviolet-curable polymer thin film;
forming a first polymer pattern having partial curing layers by radiating the flown polymer thin film with ultraviolet rays;
flowing the partial curing layers by capillary force by bringing a second mold in contact with the partial curing layers; and
forming a second polymer pattern by radiating the flown partial curing layers with ultraviolet rays.

9. The method as claimed in claim 8, wherein the partial curing layers has hardness of 10 to 100 MPa and an elastic modulus of 100 to 1500 MPa.

10. A method of forming a hierarchical microstructure using partial curing, the method comprising the steps of:
i) flowing a ultraviolet-curable polymer thin film by capillary force by bringing a first mold in contact with the ultraviolet-curable polymer thin film;
ii) forming a first polymer pattern having partial curing layers by radiating the flown polymer thin film with ultraviolet rays;
iii) placing a second mold on the partial curing layers by a specific pressure and transferring the partial curing layers to the second mold; and
iv) forming a bridge structure in which the flown partial curing layers moves along the second mold and connects to an adjacent first polymer pattern by applying a decompression condition to the flown partial curing layers.

11. The method as claimed in claim 10, wherein at the step iii), the specific pressure is 0.1 to 0.5 bar.

12. The method as claimed in claim 10, wherein at the step iii), the flow of the partial curing layers is generated upwardly from the partial curing layers.

13. The method as claimed in claim 10, further comprising flowing the transferred partial curing layers along a shape of the second mold by capillary force, after the step iii).

14. The method as claimed in claim 10, wherein the decompression condition is 10⁻² to 10⁻¹² Pa.

15. The method as claimed in claim 10, wherein a pattern having one or more of a line form, a circle, and a mesh form connecting the adjacent first polymer pattern are formed in the second mold.
